(19) United States
(12) Patent Application Publication
(10) Pub. No.: US 2015/0089907 A1
(43) Pub. Date: Apr. 2, 2015

(54) CENTRIFUGAL SPARK ARRESTOR ASSEMBLY

(71) Applicants: John Reid, Royal Oak, MI (US); Jerry Douglas, Fraser, MI (US); Mike Hattingh, Troy, MI (US)

(72) Inventors: John Reid, Royal Oak, MI (US); Jerry Douglas, Fraser, MI (US); Mike Hattingh, Troy, MI (US)

(21) Appl. No.: 14/503,912

(22) Filed: Oct. 1, 2014

Related U.S. Application Data
(60) Provisional application No. 61/885,031, filed on Oct. 1, 2013.

(51) Int. Cl. A62C 4/00; B04C 3/06

(52) U.S. Cl. CPC A62C 4/00; B04C 3/06; B04C 2003/006
USPC 55/452; 55/456; 55/461

(57) ABSTRACT

A centrifugal spark arrestor having a main body portion with a first end and a second end spaced from one another. The main body has an interior wall defining a flow path for the flow of air through the main body and a longitudinal axis. An inlet is positioned at the first end and extends generally perpendicular to the longitudinal axis. The inlet is in operative communication with the flow path. An outlet is positioned at the second end; the outlet is in operative communication with the flow path. At least one baffle is positioned within the main body portion between the first and second ends, partially extending into the flow path. Air is pulled into the inlet and forced initially in a direction perpendicular to the longitudinal axis and against the interior wall. The air is forced through the main body portion to the outlet in a centrifugal flow path. The baffle is engaged by the air flowing through the main body portion with any particles entrained within the air impinging upon the baffle.

### RELATED APPLICATIONS

This application claims the benefit of U.S. Provisional Application No. 61/885,031 filed on Oct. 1, 2013.

### STATEMENT REGARDING FEDERALLY SPONSORED RESEARCH

NONE

### TECHNICAL FIELD

This invention relates generally to spark arrestors used in commercial and industrial air filtering systems and, more particularly, to a centrifugal spark arrestor assembly.

### BACKGROUND OF THE INVENTION

Air filtering systems are commonly used in manufacturing facilities, particularly those in which welding, cutting and grinding operations are performed. For example, in a typical welding station located within a manufacturing facility, there is a direct connection, usually through ducting, to an air filtering system. The air filtering system pulls air from the welding station through a series of air filters, filter medium, and then discharges the filtered air back into the facility.

One problem with filtering air from for example a welding, cutting, or grinding operation is that the air has entrained material that can include sparks. If these sparks are pulled into the filtering material they can cause fires. Typically, to prevent fires, a spark arrestor is mounted between the source of the sparks and the filter medium within the filtering unit to capture the sparks so that they cannot enter the filter medium. The spark arrestor near the source of the sparks, at the intake into the ductwork, or connected as part of the ductwork system part way between the intake point and the filtering unit, or at the point where the air enters the filtering unit itself.

One type of common spark arrester is a series of screens that attempt to capture the spark before the spark can enter the filter medium. The screen type spark arresters have several disadvantages, including the need for regular maintenance that requires either replacement of the screens or cleaning of the screens. It is very common for the sparks that are captured to clog the filter screens. Additionally, contaminants within the air can further clog the screen reducing the flow of air to the filters. Additionally, screens are not typically effective at capturing and/or cooling the sparks before they enter the filter material.

Another style of spark arrestor is illustrated in U.S. Pat. Nos. 7,416,573 and 7,588,611. This style of spark arrestor forces the spark into a series of radially extending blades to attempt to cool the spark before the spark can enter the filter medium. Although claimed as being more effective than standard screens, this style of spark arrestor still allows some sparks to reach the filter medium and due to its design reduces the air flow through the filter medium due to the blades restricting airflow, and also causes the motor and blower to consume more energy in performing their work, due to the restricted airflow.

### SUMMARY OF THE INVENTION

In general terms, the present invention provides a spark arrestor that removes heat and energy from sparks being conveyed in the smoke and fume extraction ductwork as part of an industrial ventilation system. For example, typical industrial ventilation systems can be used in a manual or robotic welding operation, grinding or metal cutting, or plasma or laser cutting tables or robots. All of these operations can produce sparks.

In the disclosed invention, air is introduced into a circular chamber, in a manner to induce rapid circular rotation, causing particulate and sparks conveyed in the airstream to be flung axially outward though centrifugal force. The contact between the spark and the face of the device extinguishes the spark. Heat and energy is removed from the spark by conduction, due to contact with the lower temperature conductive surface of the device. The spark contacting the surfaces of the device disrupts the high-energy envelope that surrounds the spark to aid in extinguishing the spark. The spark contacting the surfaces of the device also causes larger sparks to break into multiple smaller sparks that are then extinguished much faster.

The present invention solves the problem of the lit spark being conveyed at high velocity into the dust collector filter plenum, where it can potentially start a fire, due to the ideal fire conditions being present (Fuel, Oxygen Supply, Source of Ignition).

The present invention solves the problem of particulate accumulating on spark arresting screens, which require periodic maintenance. The present invention requires little or no maintenance to keep free of accumulating particulate.

There are a number of different designs and features that can be incorporated—inlet directors, rings, spirals, baffles, outlet transitions, etc. One type can be used ‘inline’; having both the inlet and outlet connecting to round ductwork, to be used midstream between operation pick-up point, and dust collector termination point.

Another type can be mounted to the side of the dust collector wall, having a round ductwork inlet, and a rectangular transition and expansion to outlet the air into the dust collector, at a reduced velocity over a larger area (for distribution around the filter cartridges inside the dust collector).

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of a first embodiment of the present invention;

FIG. 2 is a perspective view of a second embodiment of the present invention;

FIG. 3 is a perspective view of a third embodiment of the present invention;

FIG. 4 is a side view of the third embodiment of the present invention;

FIG. 5 is a cross-sectional view taken along line A-A of FIG. 4;

FIG. 6 is a cross-sectional view taken along line B-B of FIG. 4;

FIG. 7 is a cross-sectional view taken along line C-C of FIG. 4;

FIG. 8 is a cross-sectional view taken along line D-D of FIG. 4;

FIG. 9 is a perspective view of a fourth embodiment of the present invention;

FIG. 10 is a perspective view of a fifth embodiment of the present invention;

FIG. 11 is a perspective view of a sixth embodiment of the present invention;

FIG. 12 is a top view of a sixth embodiment of the present invention; and

FIG. 13 is a side view of the sixth embodiment of the present invention.

FIG. 14 is a perspective view of a seventh embodiment of the present invention;

FIG. 15 is top view of the seventh embodiment of the present invention;

FIG. 16 is a side view of the seventh embodiment of the present invention; and

FIG. 17 is a further side view of the seventh embodiment of the present invention.

### DETAILED DESCRIPTION OF A PREFERRED EMBODIMENT

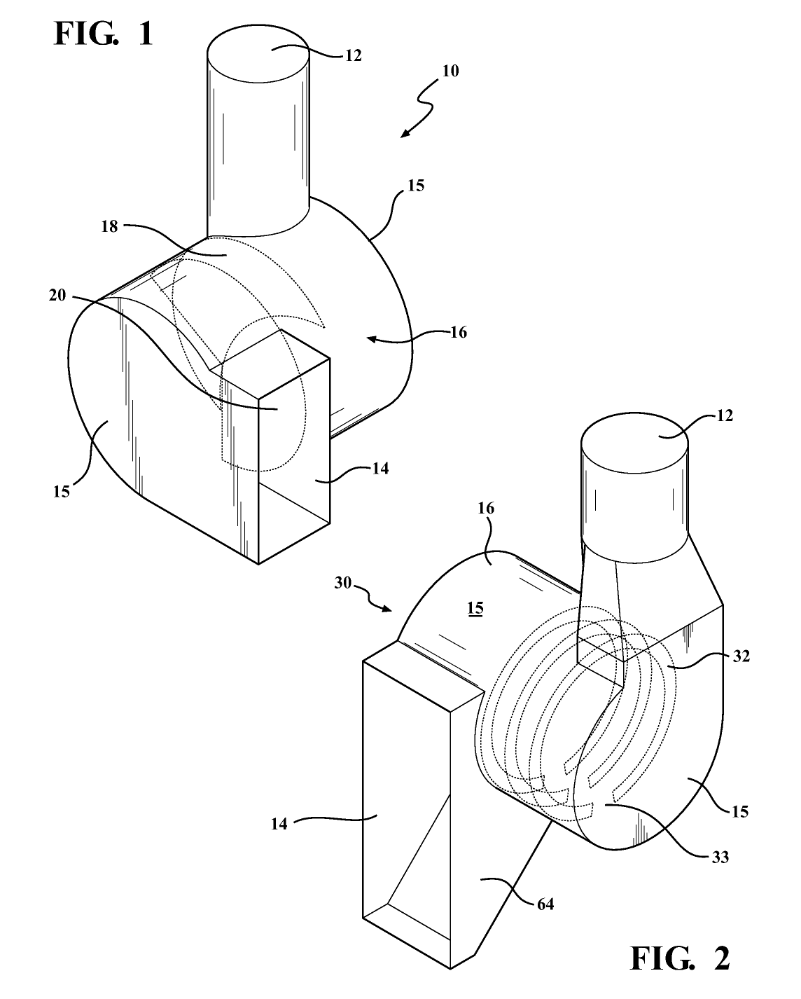

A first embodiment of the centrifugal spark arrestor assembly of the present invention is shown generally at 10 in FIG. 1. The centrifugal spark arrestor assembly 10 has an inlet 12, an outlet 14 and a main body 16. In use, the inlet 12 is operatively connected to an area such as a workstation, which can be for example a welding station. The workstation is not illustrated but will be known to anyone of ordinary skill in the art. The operative connection can include any typical connection, such as for example, a tubular conduit that extends adjacent to the work area and connects directly to the inlet 12. The outlet 14 is operatively connected to an industrial air-filtering unit. The applicant of the present invention is a manufacturer of industrial air-filtering units. As will be understood by those of ordinary skill in the art, depending upon the application, various industrial air-filtering units could be used in connection with the spark arrestor assembly of the present invention. Furthermore, as will be appreciated by those of ordinary skill in the art, the outlet 14 can be directly connected to the air-filtration unit or can be connected to the air-filtration unit through a duct assembly depending upon the application. In operation, the air-filtering system has at least one blower that draws air from the station 12, through the spark arrestor assembly and pulls the air through filter media in the air-filtering unit to filter the air.

The main body 16 of the spark arrestor assembly 10 of the present invention is generally tubular in shape and in the illustrated embodiment includes a first baffle 18 and a second baffle 20. The main body 16 of this embodiment is closed at both ends 15. In all embodiments, the spark arrestor is made of metal, such as for example steel, aluminum, etc. As illustrated, the first baffle 18 has a generally crescent shape and the second baffle 20 has a pie shaped section removed from the baffle 20. The inlet 12 intersects the body portion perpendicular to the longitudinal axis of the body portion 16. As illustrated, the outlet 14 also intersects the body portion 16 perpendicular to the longitudinal axis of the body portion 16. When the air is drawn through the spark arrestor assembly 10 perpendicular to the longitudinal axis of the body 16, at the inlet 12 and outlet 14, the air is forced to spin within the main body 16 creating centrifugal force within the main body 16 and forces any entrained material to collide and slide along the inner wall of the main body 16. This collision of the entrained material dissipates the energy held by the entrained material. The contact between any spark and the interior walls of the body portion 16 and the baffles 18 and 20 extinguishes the spark. Heat and energy is removed from the spark by conduction, due to contact with the lower temperature conductive surface of the walls of the body portion 16 and the baffles 18 and 20. The spark contacting the surfaces of the body portion 16 and the baffles 18 and 20 disrupts the high-energy envelope that surrounds the spark to aid in extinguishing the spark.

In use, the blower in the air-filtering assembly draws air from the workstation through the spark arrestor assembly 10 and then through the air-filtering unit. When the workstation includes for example, a welding operation, the air that is pulled through the spark arrester will include entrained material including molten sparks that must cool prior to entering the filter unit to avoid the potential for fire within the filtering unit. The air and the entrained material including the molten sparks will be forced through centrifugal force against the inner wall of the main body 16 and spun along the wall and then against the first baffle 18. The surface area of the inner wall of the main body 16 and the first baffle 18 dissipates the heat of the material and the molten sparks as they collide and move along the surface area. The air and entrained cooled material are pulled through the open space of the crescent baffle 18 to further engage the inner wall of the main body 16 through centrifugal force and to engage the second baffle 20. Again, any heat remaining within the spark is further dissipated over the surface area as it collides and moves along the surface area. The air is then pulled through the pie shaped opening of the second baffle 20 with the entrained material being cooled even further along the remaining inner wall of the main body 16 to further and optimally completely cool the material as it is finally drawn through the exit 14 and into the filtering system. In this way, there are no hot sparks entering the filter media and the spark arrestor is self-cleaning, since all the entrained material is pulled through the body 16 and exits through the outlet 14.

The baffles 18 and 20 provide additional surface area and obstructive surfaces to dissipate the heat from the entrained sparks. The baffles 18 and 20 also are designed to avoid the reduction of air-flow through the spark arrestor 10 while still cooling the sparks that pass through the arrestor 10. Additionally, the overall design of the spark arrestor assembly reduces the need for maintenance, since the system is self-cleaning, by drawing the entrained material along the surfaces and through the assembly.

With reference to FIG. 2, a second embodiment of the centrifugal spark arrestor of the present invention is illustrated at 30. In this embodiment, as in the last embodiment, there is an inlet 12, and outlet 14 and a main body 16 closed at both ends 15. In the centrifugal spark arrestor assembly 30, the baffles 32 are 3 a series of spaced open rings. In this embodiment, the air is pulled into the inlet 12 generally perpendicular to the longitudinal axis of the main body 16 to create a centrifugal flow through the body 16. Material entrained in the air-flow impinges upon the inner wall of the body 16 as well as along the surfaces of the rings 32. As the material flows across the individual rings 32, it exits each individual ring 32 at the opening or exit 33 to engage the adjoining ring 32. Due to the centrifugal force of the air, the entrained particles are forced to engage and slide along the spaced rings 32 extending outwardly from the inner wall of the body 16. In this embodiment, there is a plenum 64 that is mounted to the air filter.

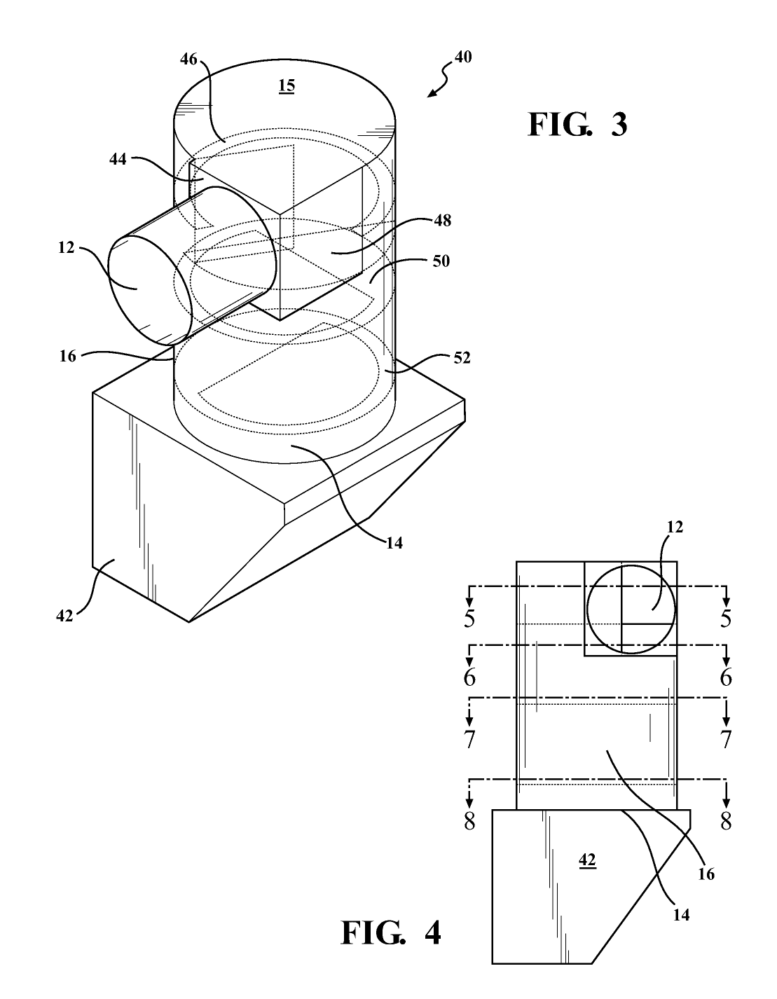

With reference to FIG. 3, a third embodiment of the present invention is shown generally at 40. As with the previous embodiments, there is an inlet 12, an outlet 14 and a main body portion 16. In this embodiment, only one end 15 is closed, the opposite end is open and forms the outlet 14. Mounted within the main body portion 16 adjacent the inlet 12 is a first flow direction plate 44. The plate 44 directs the airflow directly into the inner wall of the body 16 and initiates the centrifugal flow of air. The air initially is forced against a first ring 46 that extends partially around the perimeter of the inner wall of the body 16. Positioned directly below the ring 46 is a partial plate 48 that extends outwardly from the inner wall 16 and partially into the interior of the body 16. Positioned below the partial plate 48 are two generally ring shaped plates 50 and 52, each having a portion cutaway to form openings 54 as shown in FIGS. 7 and 8. The outlet 14 of this embodiment empties into a plenum 42 that is connected to the air filter assembly, which is not shown.

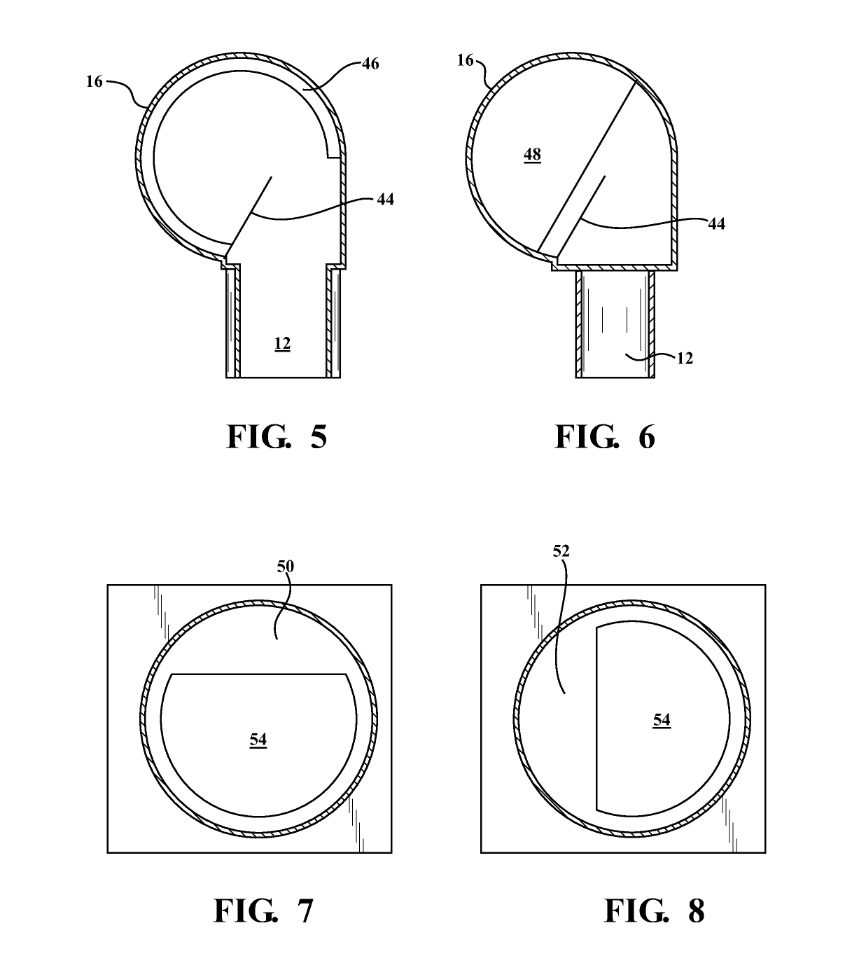

FIG. 4 is a side view of the spark arrestor assembly 40 and FIGS. 5 through 8 are cutaway sections taken along sections A-A, B-B, C-C and D-D of FIG. 4.

As in the previous embodiments, the air flowing into the spark arrestor assembly is forced into a centrifugal flow with the material entrained in the air being forced to the outer wall of the main body 16 and forced to impinge upon the baffles 44, 46, 48, 50 and 52 mounted within the body 16.

With reference to FIG. 9, a fourth embodiment of the present invention is shown generally at 60. As with previous embodiments, there is and inlet 12, outlet 14 and body 16 and both ends 15 are closed. The air enters the inlet 12 and is forced into a centrifugal flow. A plurality of rings 62 extend outwardly from the inner wall of the body 16 to provide further surface area for any entrained material, particularly hot sparks to impinge and release heat to cool the spark. In this embodiment, a plenum 64 is provided.

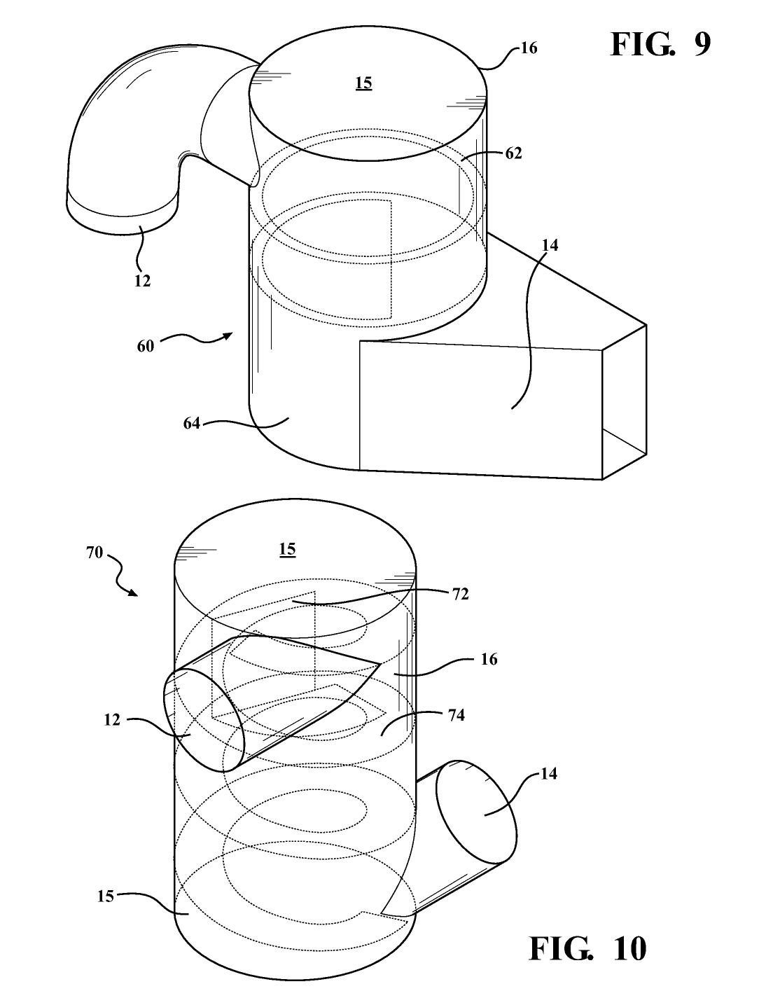

With reference to FIG. 10, a fifth embodiment of the spark arrestor of the present invention is shown generally at 70. In this embodiment, as in the previous embodiments, there is an inlet 12 which is positioned generally perpendicular to the longitudinal axis of the main body 16, an outlet also generally positioned perpendicular to the longitudinal axis of the main body 16 to create centrifugal airflow within the main body 16. Both ends 15 of the main body 16 are closed. In this embodiment, there is a deflector plate 72 position adjacent the inlet 12 to deflect the airflow against the inner wall of the body 16. Positioned within the main body 16 there is an extended spiral baffle 74. As the air is pulled through the spark arrestor assembly, the entrained material including any sparks, are forced by the centrifugal force of the airflow to the inner walls of the main body 16 and against and along the surface of the spiral baffles 74. As with previous embodiments, as the sparks impinge upon the surfaces, the sparks are cooled before exiting the outlet 14.

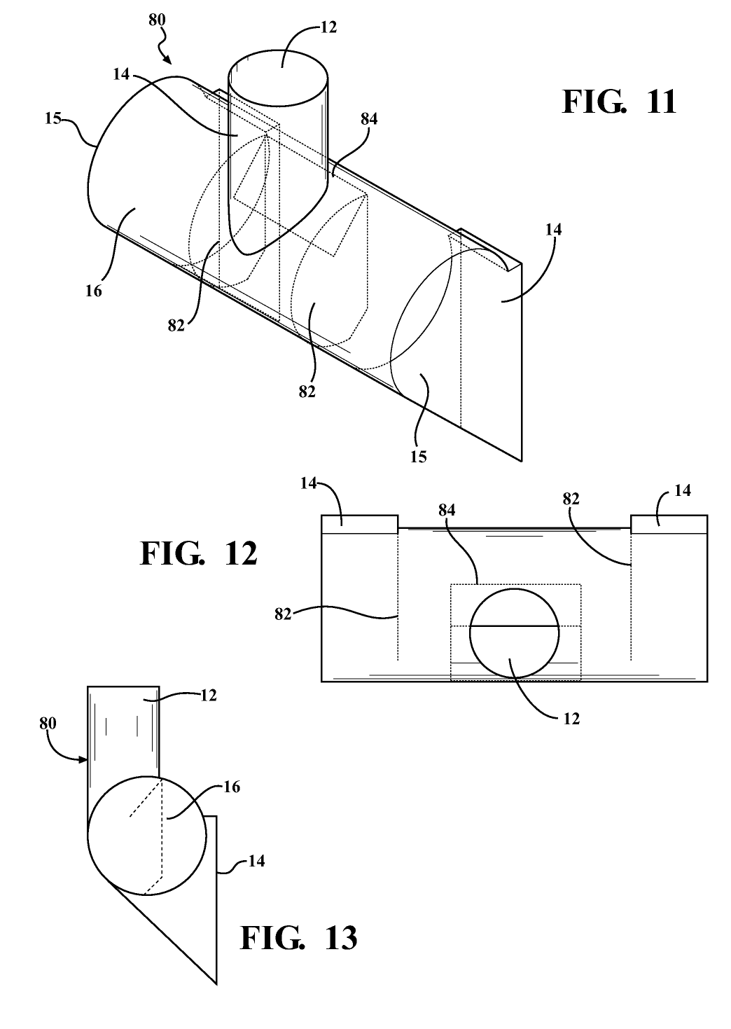

With reference to FIG. 11, a sixth embodiment of the present invention is shown generally at 80. This embodiment includes an inlet 12, two outlets 14 and a body 16. In this embodiment, there are a pair of baffles 82 which partially extend from the inner walls of the body 16, partially into the interior of the main body 16. FIG. 12 is a top view of the spark arrestor shown generally at 80 and FIG. 13 is a side view of the spark arrestor 80.

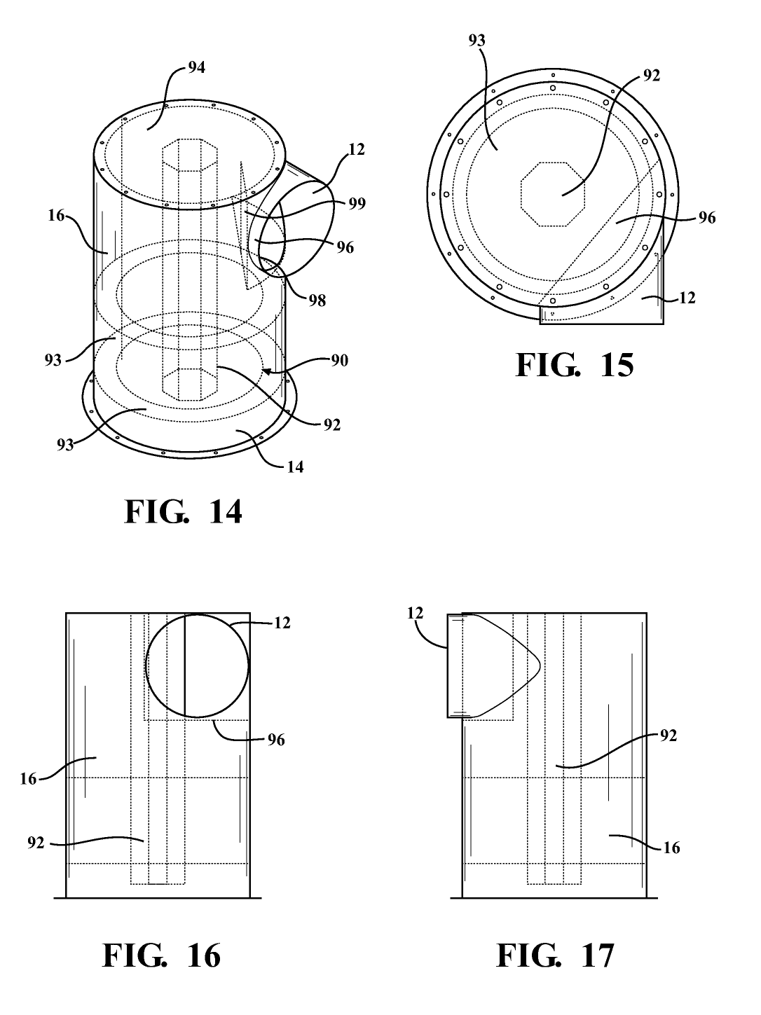

With reference to FIGS. 14 through 17, a seventh embodiment of the present invention is shown generally at 90. In this embodiment, like previous embodiments, the spark arrestor has an inlet 12, and outlet 14 and a body portion 16. The body portion, like previous embodiments includes an inner or interior wall 94. A cap 93 closes off the body portion 16 generally adjacent to the inlet 12. A central tube 92 is mounted to and extends from the cap 93 down the center of the main body portion 16 generally along the longitudinal axis. As disclosed, the central rod is an eight-sided rod, but could be any number of sides or circular in cross section. The use of multiple sides provides more surfaces for the entrained material to collide against and dissipate energy, however, as indicated, other shapes are within the scope of the invention. The central tube 92 facilitates the direction of the air flowing into the spark arrestor in a centrifugal direction and against the inner wall 94. The central tube 92 increases the centrifugal action of the air flow in the spark arrestor 90.

The embodiment of FIGS. 14 through 17 also include an inlet diverter 96 which in this embodiment includes a base 98 to which the diverter 96 is mounted to the inner wall 94 and a vane 99 that extends into the air flow path to initiate the centrifugal path of the air. The base 98 prevents the air from initially flowing downwards, forcing it into the inner wall. The vane 99 also sends the air into the inner wall. Both of these together start the centrifugal action of the air flow. The vane 99 as shown is generally a square of rectangular plate, but other shapes could be used as well. The vane 99 increases the centrifugal action of the air flowing into the spark arrestor 90.

As with previous embodiments, the spark arrestor 90 includes baffles 93. These are shown as partial rings, but could be an expanded spiral, an open ring, partial plates etc., or combination of these. Additionally, the outlet is shown as being parallel to the longitudinal axis of the body portion 16, but could also be located generally perpendicular to the longitudinal axis.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A centrifugal spark arrestor comprising:
a main body portion having a first end and a second end spaced from one another, said main body having an interior wall defining a flow path for the flow of air through said main body and a longitudinal axis;
an inlet positioned at said first end and extending generally perpendicular to said longitudinal axis, said inlet being in operative communication with said flow path;
an outlet positioned at said second end, said outlet being in operative communication with said flow path;
at least one baffle positioned within said main body portion between said first and second ends, partially extending into said flow path;
whereby air is pulled into said inlet and forced initially in a direction perpendicular to said longitudinal axis and against said interior wall, said air being forced through said main body portion to said outlet in a centrifugal flow path, said at least one baffle being engaged by said air flowing through said main body portion with any particles entrained within the air impinging said at least one baffle.

2. The centrifugal spark arrestor of claim 2, wherein said at least one baffle is an open ring extending inwardly from said interior wall partially into said flow path.

3. The centrifugal spark arrestor of claim 2, further including a plurality of open rings spaced from one another.

4. The centrifugal spark arrestor of claim 2, wherein said open ring includes an exit adjacent said interior wall.

5. The centrifugal spark arrestor of claim 3, wherein said plurality open rings each include an exit adjacent said interior wall.

6. The centrifugal spark arrestor of claim 1, wherein said at least one baffle is a plate extending inwardly from said interior wall partially into said flow path.

7. The centrifugal spark arrestor of claim 1, wherein said at least one baffle includes a first partial plate extending from said interior wall partially into said flow path and a second partial plate extending from said interior wall partially into said flow path.

8. The centrifugal spark arrestor of claim 1, wherein said outlet extends generally perpendicular to said longitudinal axis.

9. The centrifugal spark arrestor of claim 1, wherein said outlet extends generally parallel to said longitudinal axis.

10. The centrifugal spark arrestor of claim 1, further including a first flow direction plate positioned adjacent said inlet, said flow direction plate directs airflow directly into said interior wall of said main body portion to initiate centrifugal flow of air.

11. The centrifugal spark arrestor of claim 10, wherein said at least one baffle is an open ring extending partially about said inner wall spaced from said first flow direction plate.

12. The centrifugal spark arrestor of claim 11, further including a partial plate extending partially into said flow path.

13. The centrifugal spark arrestor of claim 11, further including at least one ring shaped plate with an opening extending there through.

14. The centrifugal spark arrestor of claim 1, wherein said baffle is an extended spiral baffle.

15. The centrifugal spark arrestor of claim 1, further including a second outlet spaced from said outlet.

16. A centrifugal spark arrestor comprising:
a main body portion having a first end and a second end spaced from one another, said main body having an interior wall defining a flow path for the flow of air through said main body and a longitudinal axis;
an inlet positioned at said first end and extending generally perpendicular to said longitudinal axis, said inlet being in operative communication with said flow path;
an outlet positioned at said second end, said outlet being in operative communication with said flow path;
at least one baffle positioned within said main body portion between said first and second ends, partially extending into said flow path;
a central tube extending along the longitudinal axis of the body portion;
whereby air is pulled into said inlet and forced initially in a direction perpendicular to said longitudinal axis and against said interior wall, said air is forced through said main body portion and about said central tube to increase the centrifugal action within said main body to said outlet in a centrifugal flow path, said at least one baffle being engaged by said air flowing through said main body portion with any particles entrained within the air impinging said at least one baffle and said central tube.

17. The centrifugal spark arrestor of claim 16, further including a baffle at said inlet.

18. The centrifugal spark arrestor of claim 17, wherein said baffle includes a vane for increasing the centrifugal action of air flowing into said main body.

19. The centrifugal spark arrestor of claim 18, wherein said vane is generally rectangular.

20. The centrifugal spark arrestor of claim 16, wherein said central tube is multi-sided.
